(19) United States
(12) Patent Application Publication
(10) Pub. No.: US 2010/0142083 A1
(43) Pub. Date: Jun. 10, 2010

(54) MAGNETIC RECORDING MEDIUM AND MAGNETIC STORAGE DEVICE

(75) Inventor: Koichi Aikawa, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/634,584

(22) Filed: Dec. 9, 2009

(30) Foreign Application Priority Data
Dec. 10, 2008 (JP) 2008-314964

(51) Int. Cl. G11B 21/02

(52) U.S. Cl. 360/75; G9B/21.003

(57) ABSTRACT

According to one embodiment, a magnetic recording medium includes a substrate and a single domain magnetic dot. The single domain magnetic dot is provided on the substrate and is written with a compensation signal for controlling the position of at least one of a recording device and a reproducing device. The single domain magnetic dot has a length in the radial direction of the substrate shorter than a length in the circumferential direction of the substrate.

### CROSS-REFERENCE TO RELATED APPLICATIONS

This application is based upon and claims the benefit of priority from Japanese Patent Application No. 2008-314964, filed Dec. 10, 2008, the entire contents of which are incorporated herein by reference.

### BACKGROUND

1. Field

One embodiment of the invention relates to a magnetic recording medium and a magnetic storage device and, in particular, to a magnetic recording medium for storing information and a magnetic storage device that drives the magnetic recording medium.

2. Description of the Related Art

Research for increasing the surface recording density of magnetic recording media, such as a hard disk drive (HDD), has been conducted in recent years to increase the recording capacity thereof. As a result, the size of a recording bit on a magnetic recording medium has become as small as several tens of nanometers. Securing as large saturation magnetization and film thickness as possible for each bit is required to obtain reproduction output from such small recording bits. However, because smaller recording bits result in smaller magnetization per bit, magnetization reversal due to thermal fluctuations is likely to occur, and accordingly, magnetized information may likely to be lost.

Even when the magnetic grain diameter of a granular material is made smaller to improve the signal-to-noise (S/N) ratio, the magnetized information may be lost because of magnetization reversal due to thermal fluctuations. Specifically, when magnetic anisotropy energy necessary for maintaining the orientation of magnetization of magnetic particles in one direction reaches the level of thermal fluctuation energy at the room temperature, magnetization fluctuates over time and thereby recorded information is lost.

Generally, the larger the value of Ku·V/kT (where Ku is an anisotropy constant, V is a magnetization minimum unit volume, k is the Boltzmann constant, and T is an absolute temperature) is, the smaller the influence of thermal fluctuations is. In other words, using a material having a larger anisotropy constant Ku as the magnetic material is one solution to suppress the influence of thermal fluctuations. However, few head magnetic materials having a larger Ku can generate a magnetic field necessary for writing information (data) in the material.

By contrast, Japanese Patent Application Publication (KOKAI) No. 2001-17604 discloses a magnetic recording medium called a patterned medium as a medium for suppressing magnetization reversal due to thermal fluctuations, which is attracting attention recently. The patterned medium is a magnetic recording medium in which a plurality of magnetic body areas of a single domain to be a recording bit unit is formed independently in a non-magnetic body layer. Because a magnetic thin film in the patterned medium is divided into the size of a recording domain, a magnetization minimum unit volume V can be increased, whereby thermal fluctuations can be avoided.

The patterned medium generally comprises a data part for recording information and a servo part used, for example, in positioning a magnetic head. In this case, not only the data part but also the servo part needs to be made of a single domain material.

The servo part comprises an area where servo address information is recorded, an area where servo burst information is recorded, an area where compensation information (eccentricity compensation signal) is recorded, and the like. On the area where servo address information is recorded and the area where servo burst information is recorded, the information is recorded in advance. Meanwhile, on the area where an eccentricity compensation signal is recorded, it is necessary to write compensation information (eccentricity compensation signal) after assembling a device. Accordingly, the area provided on the patterned medium where an eccentricity compensation signal is recorded is preferably a continuous area to deal with various signals. Because a recording device and a reproducing device configuring the magnetic head are offset to some degree in the radial direction of the magnetic recording medium, and the offset amount varies for each device, the area where an eccentricity compensation signal is recorded is preferably a continuous area to enable writing and reproduction of an eccentricity compensation signal regardless of the offset amount.

However, a continuous area cannot be formed of a single domain material. In addition, a compensation signal may be lost due to thermal fluctuations when the size of a recording bit on the compensation signal area is made excessively small.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a configuration of a hard disk drive (HDD) according to an embodiment of the invention;

FIG. 2 is an exemplary schematic diagram of a format of a magnetic disk in the embodiment;

FIG. 3 is an exemplary block diagram of a control system of the HDD in the embodiment;

FIGS. 4A and 4B are exemplary enlarged plan views of part of a postcode area and a data area in the embodiment;

FIG. 5A is an exemplary schematic diagram of offset of a reproducing device and a recording device in the embodiment;

FIG. 5B is an exemplary schematic diagram of a compensation amount of the recording device and the reproducing device in the embodiment;

FIG. 6A is an exemplary schematic diagram of an area where an eccentricity compensation signal for the recording device is written in the embodiment; and

FIG. 6B is an exemplary schematic diagram of an area where an eccentricity compensation signal for the reproducing device is written in the embodiment.

### DETAILED DESCRIPTION

Various embodiments according to the invention will be described hereinafter with reference to the accompanying drawings. In general, according to one embodiment of the invention, A magnetic recording medium comprises a substrate and single domain magnetic dots. The single domain magnetic dots are located on the substrate and configured to be written with a compensation signal for controlling the position of at least one of a recording device and a reproducing device. The single domain magnetic dots are each configured to have a length in the radial direction of the substrate shorter than a length in the circumferential direction of the substrate.

According to another embodiment of the invention, a magnetic storage device comprises a driving module, a magnetic head, a head actuator, and a controller. The driving module is configured to drive and rotate a magnetic recording medium comprising a substrate and a single domain magnetic dot on the substrate. The single domain magnetic dot is configured to be written with a compensation signal for controlling the position of at least one of a recording device and a reproducing device. The single domain magnetic dot is configured to have a length in the radial direction of the substrate shorter than a length in the circumferential direction of the substrate. The magnetic head comprises the reproducing device configured to reproduce data from the magnetic recording medium. The head actuator is configured to move the magnetic head in the radial direction of the magnetic recording medium. The controller is configured to adjust the position of the magnetic head by reading the compensation signal written to the single domain magnetic dot of the magnetic recording medium by the reproducing device.

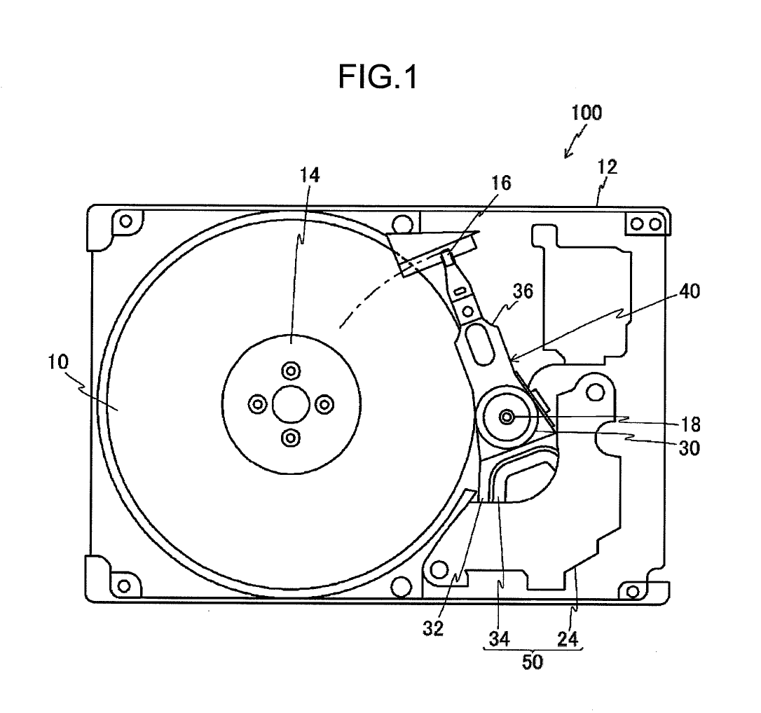

FIG. 1 is a schematic diagram of an internal configuration of a hard disk drive (HDD) 100 as a magnetic recording device according to an embodiment of the invention. As illustrated in FIG. 1, the HDD 100 comprises a box-shaped housing 12, a magnetic disk 10 as a magnetic recording medium housed in a space (housing space) in the housing 12, a spindle motor 14 as a driving module, and a head stack assembly (HSA) 40 as a head actuator. The housing 12 is actually configured of a base and a top lid (top cover), but only the base is illustrated in FIG. 1 for convenience of illustration.

The front surface of the magnetic disk 10 is a recording surface, and the magnetic disk 10 is driven by the spindle motor 14 to rotate about a rotary axis at a high speed of, for example, 4200 to 15000 revolutions per minute (rpm). Both the front surface and the rear surface of the magnetic disk 10 may be recording surfaces. A plurality of such magnetic disks (10) may be provided aligned in a direction perpendicular to the sheet surface of FIG. 1.

The magnetic disk 10 is a patterned medium (bit patterned medium), and its recording surface comprises a single crystal, single domain magnetic film separated into bits. The details of the magnetic disk 10 are explained below.

The HSA 40 comprises a cylindrical carriage 30, a fork 32 fixed to the carriage 30, a coil 34 supported by the fork 32, a carriage arm 36 fixed to the carriage 30, and a head slider 16 supported by the carriage arm 36. When both the front surface and the rear surface of the magnetic disk 10 are recording surfaces, two pairs of the carriage arm and the head slider are provided vertically and symmetrically with the magnetic disk 10 therebetween. When a plurality of magnetic disks are provided, carriage arms and head sliders are provided correspondingly to the number of the recording surfaces of the magnetic disks.

The carriage arm 36 is molded by, for example, press-cut of a stainless steel or extrusion of an aluminum material. The head slider 16 comprises a record/reproduction head (hereinafter, “magnetic head”) comprising a recording device 44 and a reproducing device 42 (see FIG. 3).

The HSA 40 is rotatably coupled to the housing 12 (rotatable about the Z axis) through a bearing member 18 provided at the center of the carriage 30. The HSA 40 is swung about the bearing member 18 by a voice coil motor 50 configured of the coil 34 of the HSA 40, and a magnetic pole unit 24 comprising a permanent magnet fixed to the base of the housing 12. The orbit of the swing is indicated by a dashed line in FIG. 1.

In the HDD 100 thus configured, the magnetic head provided at an end of the carriage arm 36 reads/writes data (information) from/to the magnetic disk 10. The head slider 16 retaining the magnetic head floats from the front surface of the magnetic disk 10 by a lift force generated by rotation of the magnetic disk 10, and the magnetic head performs reading/writing of data while maintaining a minute space between the magnetic head and the magnetic disk 10. Due to the swing of the carriage arm 36, the magnetic head seeks and moves in a direction transverse across the tracks of the magnetic disk 10 to a read/write target track.

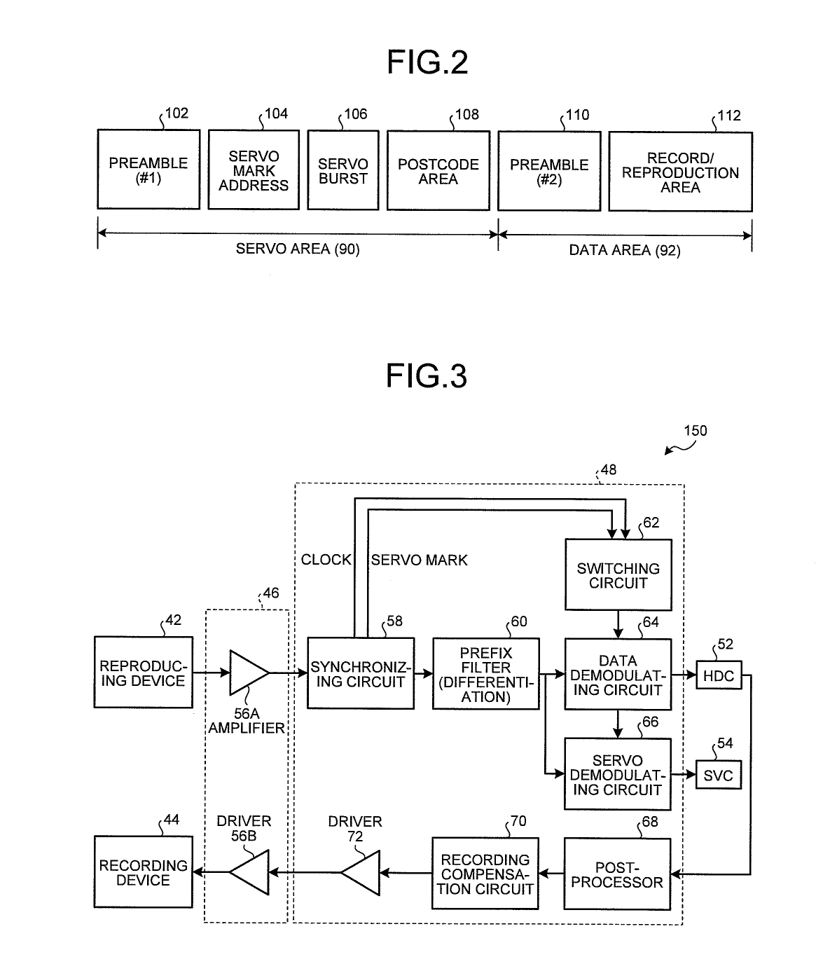

FIG. 2 is a schematic diagram of a format of the magnetic disk 10. A servo area 90 and a data area 92 illustrated in FIG. 2 are provided alternately in the circumferential direction on the magnetic disk 10.

A preamble (#1) 102, a servo mark address 104, and a servo burst 106 are recorded on the servo area 90 in advance. A postcode area 108 is provided on the rear side of the servo burst 106. On the postcode area 108, eccentricity compensation data is recorded using the recording device 44 after the magnetic disk 10 is incorporated into the HDD 100.

A preamble (#2) 110, and an area on which data (read/write data) is recorded (record/reproduction area 112) are provided in the data area 92.

FIG. 3 is a block diagram of a control system 150 as a controller of the HDD 100. As illustrated in FIG. 3, the control system 150 comprises a preamplifying module 46, a reading/writing module 48, a hard disk controller (HDC) 52, and a servo controller (SVC) 54.

The preamplifying module 46 comprises an amplifier 56A and a driver 56B. The reading/writing module 48 comprises a synchronizing circuit 58, a prefix filter 60, a switching circuit 62, a data demodulating circuit 64, a servo demodulating circuit 66, a postprocessor 68, a recording compensation circuit 70, and a driver 72.

Information (data) reproduced from the magnetic disk 10 (see FIG. 1) by the reproducing device 42 is supplied to the data demodulating circuit 64 and the servo demodulating circuit 66 through the amplifier 56A, the synchronizing circuit 58, and the prefix filter 60. The synchronizing circuit 58 generates a clock and a servo mark from the reproduced information, and supplies them to the switching circuit 62. The switching circuit 62 switches between the data demodulating circuit 64 and the servo demodulating circuit 66 based on the clock and the servo mark so that output of the prefix filter 60 is demodulated by the servo demodulating circuit 66 while the servo area is being reproduced, and output of the prefix filter 60 is demodulated by the data demodulating circuit 64 while the data area is being reproduced.

The reproduced data output from the data demodulating circuit 64 is supplied to the HDC 52. Meanwhile, the servo information output from the servo demodulating circuit 66 is supplied to the SVC 54. The reproduced data is output to other parts in the HDD 100 or to the outside through the HDC 52. The SVC 54 uses the reproduced servo information for various control operations of the HDD 100.

On the other hand, in recording, data to be recorded is supplied to the recording device 44 through the HDC 52, the postprocessor 68, the recording compensation circuit 70, and the drivers 72 and 56B. The recording device 44 records the data to be recorded after the preamble (#2) 110 in the data area on the magnetic disk 10.

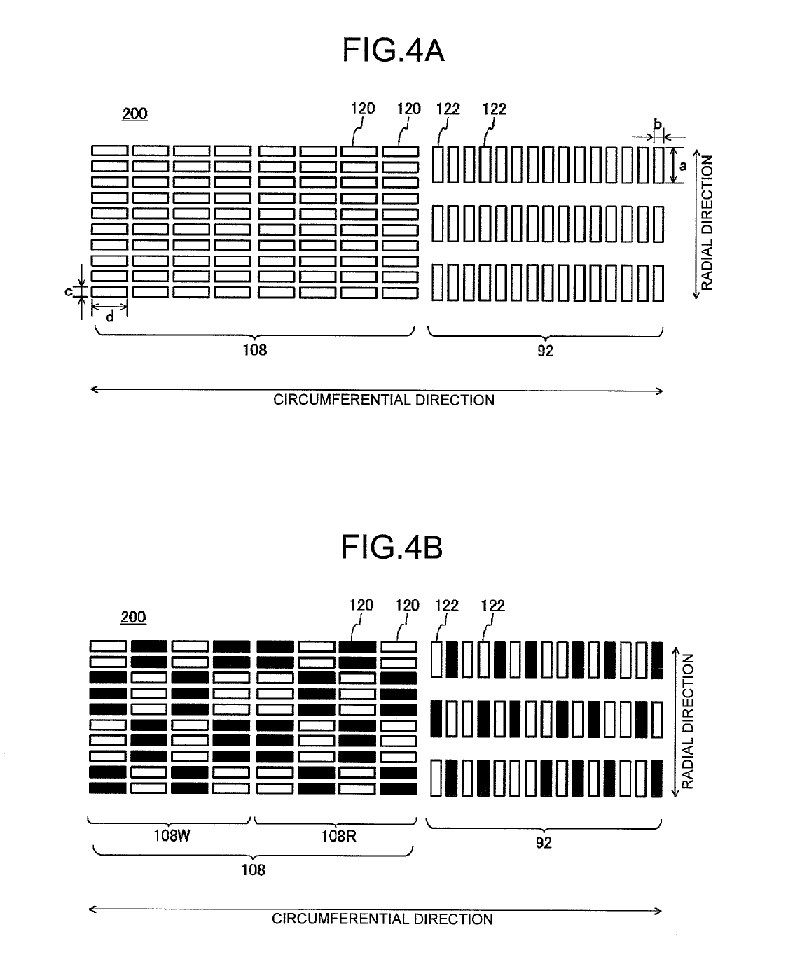

FIG. 4A is an enlarged plan view of the postcode area 108 and the data area 92 illustrated in FIG. 2. The vertical direction of FIG. 4A corresponds to the radial direction of the magnetic disk 10, and the horizontal direction corresponds to the circumferential direction of the magnetic disk 10.

As illustrated in FIG. 4A, in the embodiment, bit patterns are formed as single domain magnetic dots on a disk-shaped disk substrate 200 as a base material of the magnetic disk 10. Among the bit patterns, a bit pattern 122 belonging to the data area 92 (the single domain magnetic dot for writing data or information) has a length (a) in the radial direction that is set to be longer than a length (b) in the circumferential direction (a>b). The lengths a and b have the relationship a>b because the following requirements have to be met:
(1) the length (b) in the circumferential direction needs to be minimized to increase the recording density and the transmission speed
(2) the area of the bit pattern 122 needs to be larger than a minimum necessary area with which magnetic loss does not occur (minimum necessary area S) because magnetic loss due to thermal fluctuations may occur if the area of the bit pattern 122 is excessively small To meet the requirements, the length (a) in the radial direction inevitably becomes longer.

On the other hand, bit patterns 120 belonging to the postcode area 108 (the single domain magnetic dot for writing a compensation signal) are arranged concentrically, and a length (c) in the radial direction is set to be shorter than a length (d) in the circumferential direction (c<d). Assuming that the aspect ratio (horizontal-to-vertical ratio) of the bit pattern 122 in the data area 92 to be a/b, c and d are set so that the aspect ratio c/d of the bit pattern 120 in the postcode area 108 is the reciprocal of a/b (i.e., c/d=b/a).

In the embodiment, the lengths c and d of the bit pattern 120 have the relationship c<d because the following requirements have to be met:
(1) the area is preferably equal to or larger than the minimum necessary area S considering the occurrence of magnetic loss due to thermal fluctuations
(2) the number of the bit patterns 120 arrayed in the radial direction needs to be maximized without lowering the recording density To meet the requirements, the length (c) in the radial direction needs to be shorter than the length (d) in the circumferential direction. The number of the bit patterns 120 in the postcode area 108 arrayed in the radial direction is maximized as the requirement (2) because this allows a set of the bit patterns 120 aligned in the radial direction to be handled almost as a continuous area (information can be written and read as if the set of the bit patterns 120 is a continuous area).

In the embodiment, the area of the bit pattern 120 may be set to be the minimum necessary area S. In this case, the lengths a, b, c, and d meet the relationships a=d and b=c, and the bit patterns 120 and 122 have the same shape. This is by way of example and not of limitation and, for example, the area of the bit pattern 120 may be different from the area of the bit pattern 122.

In FIG. 4A, the bit patterns 122 in the data area 92 are arrayed in a single row (a single track) in the circumferential direction, and the bit patterns 120 in the postcode area 108 are arrayed in about three rows.

The postcode area 108 is actually, as illustrated in FIG. 4B, divided into a postcode area 108W for the recording device (four bits in the circumferential direction in FIG. 4B) and a postcode area 108R for the reproducing device (four bits in the circumferential direction in FIG. 4B). A compensation signal for position compensation (eccentricity compensation) of the recording device 44 is recorded on the postcode area 108W for the recording device. An eccentricity compensation signal for position compensation (eccentricity compensation) of the reproducing device 42 is recorded on the postcode area 108R for the reproducing device. In this case, because the eccentricity compensation signal is acquired in advance in premeasurement after the magnetic disk 10 is mounted on the HDD 100 (before shipment), the eccentricity compensation signal is written to the postcode area 108 through the recording device 44 before shipment of the HDD 100.

In the embodiment, eccentricity compensation as explained below is possible by providing the postcode area 108.

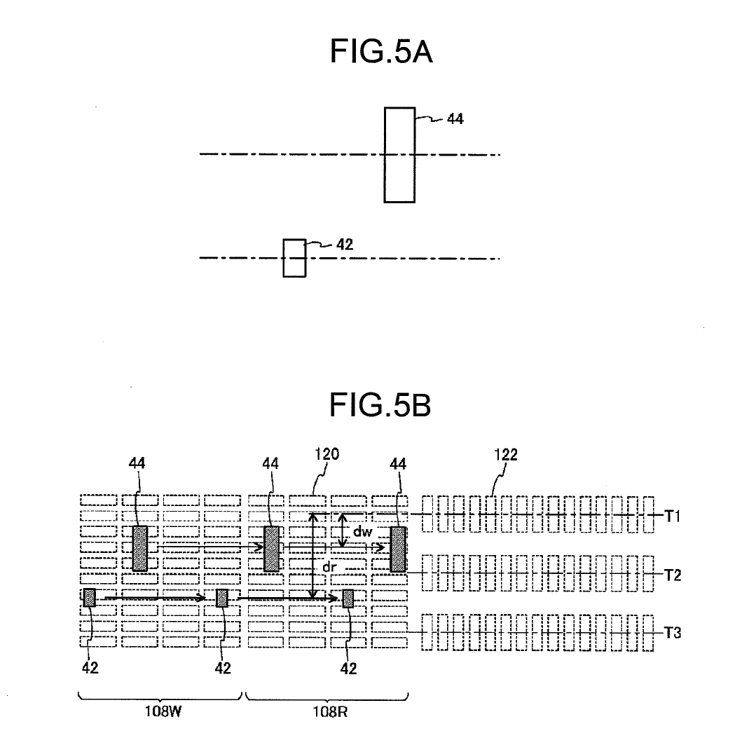

For example, it is assumed that, due to factors in manufacturing of the magnetic head, the center lines of the recording device 44 and the reproducing device 42 are offset in the radial direction as illustrated in FIG. 5A. Although the actual offset amount hardly becomes as extreme as illustrated in FIG. 5A, FIG. 5A illustrates such an extreme example for convenience of illustration and explanation.

In this case, if positioning of the magnetic head is controlled assuming that the magnetic disk 10 and the HDD 100 are not eccentric with each other although actually they are, the recording device 44 and the reproducing device 42 may be moved (moved relative to the magnetic disk 10) in the orbit as illustrated in FIG. 5B although they need to be positioned above a track T1 illustrated in FIG. 5B.

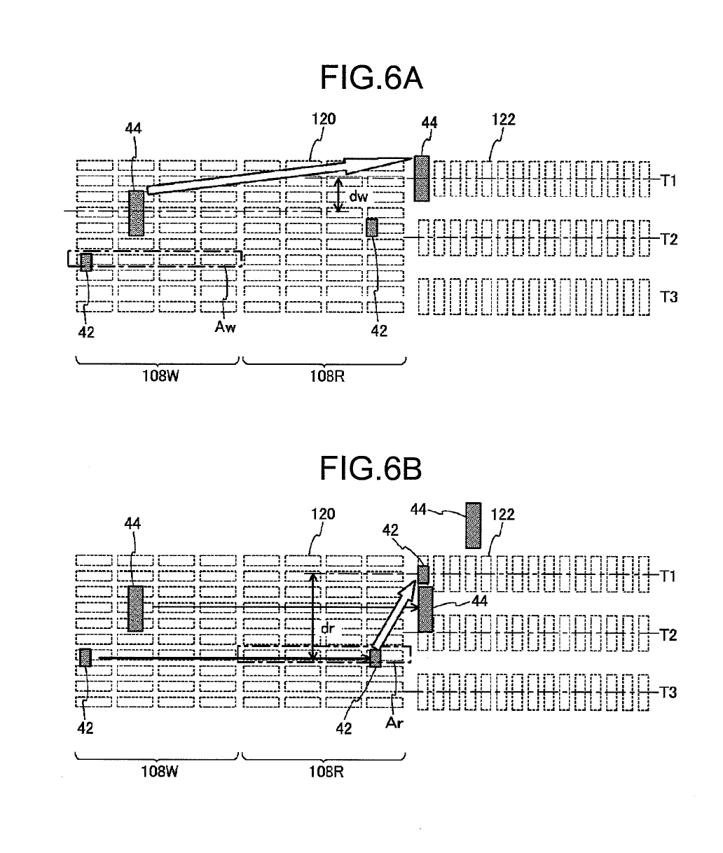

Accordingly, in the embodiment, an eccentricity compensation signal for the recording device 44 is recorded in advance (before shipment of the HDD 100) on a part of the postcode area 108W for the recording device where the recording device 44 passes immediately before recording data on the track T1 (see encircled part Aw in FIG. 6A). The eccentricity compensation signal for the recording device 44 means a value regarding a travel distance dw of the magnetic head necessary for positioning the recording device 44 above the track T1 (for example, a voltage value). In the embodiment, because about three rows of the bit patterns 120 are allocated to a track of the data area, the eccentricity compensation signal is recorded every three rows as illustrated in FIG. 4B.

An eccentricity compensation signal for the reproducing device 42 is recorded in advance (before shipment of the HDD 100) on a part of the postcode area 108R for the reproducing device where the reproducing device 42 passes immediately before reproducing data from the track T1 (see encircled part Ar in 6B). The eccentricity compensation signal for the reproducing device 42 means a value regarding a travel distance dr of the magnetic head necessary for positioning the reproducing device 42 above the track T1 (a voltage value). In this case also, the eccentricity compensation signal is recorded every three rows similarly to the postcode area 108W for the recording device (see FIG. 4B).

In the embodiment, when data is recorded in the track T1 using the recording device 44, the eccentricity compensation signal recorded on the postcode area 108W for the recording device (encircled part Aw in FIG. 6A) is read with the reproducing device 42. Then, the SVC 54 controls the voice coil motor 50 to position the recording device 44 above the track T1 based on the read result (see the white arrow in FIG. 6A). When data is reproduced from the track T1 using the reproducing device 42, the eccentricity compensation signal recorded in the postcode area 108R for the reproducing device (encircled part Ar in FIG. 6B) is read with the reproducing device 42. The SVC 54 controls the voice coil motor 50 to position the recording device 44 above the track T1 based on the read result (the white arrow in FIG. 6B).

In this manner, by positioning the magnetic head to a desired track based on an eccentricity compensation signal each time the magnetic head passes the postcode area 108 (for each sector), recording of data on each track and reproduction of data from each track can be performed highly precisely.

As described in detail above, according to the embodiment, because the bit patterns 120 for writing an eccentricity compensation signal used in controlling the recording device 44 and the reproducing device 42 each have the length c in the radial direction of the magnetic disk 10 shorter than the length d in the circumferential direction, the bit patterns 120 can be arranged at relatively small intervals in the radial direction while the area is maintained at a size where magnetic loss due to thermal fluctuations hardly occurs. Accordingly, a set of bit patterns arranged in the radial direction can be handled (information can be read from/written to) almost as a continuous area. Thus, even if there is an offset in the radial direction between the recording device and the reproducing device (as in FIG. 5A), the compensation signal can be written to a position considering the offset. Therefore, the compensation signal can be read/written without being influenced by the offset. By making the circumference length of the bit pattern 120 longer, compensation signal reading errors can be reduced upon seek operation of the magnetic head.

Besides, according to the embodiment, the aspect ratio of the bit pattern 122 in the data area 92 is equal to the reciprocal of the aspect ratio of the bit pattern 120 in the postcode area 108, and the areas of the bit patterns 122 and 120 are the same. With this, the bit patterns of the postcode area 108 can be arrayed in the radial direction while the area is maintained at a size where magnetic loss hardly occurs. Because an eccentricity compensation signal can be written to the postcode area 108 as if it is a continuous area regardless of the offset amount, the eccentricities of the recording device 44 and the reproducing device 42 can be reliably compensated. By making the shapes of the bit patterns 120 and 122 the same, the bit patterns 120 and 122 do not become extremely small or thin. Accordingly, the bit patterns can be formed easily, and lowering of recording density due to spread of the postcode area 108 in the radial direction can be suppressed the minimum.

While the aspect ratio of the bit pattern 122 in the data area 92 is described above by way of example as being equal to the reciprocal of the aspect ratio of the bit pattern 120 in the postcode area 108, it is not so limited. There may be no specific relationship between the aspect ratios.

While the bit patterns 120 and 122 are described above by way of example as being rectangular, the bit patterns 120 and 122 may have other shapes such as oval. Further, the bit pattern 120 and the bit pattern 122 may have different shapes.

Although the postcode area 108W for the recording device and the postcode area 108R for the reproducing device are described above as being of four bits for convenience of illustration, the bit number may be changed correspondingly to the data amount of an eccentricity compensation signal.

Although, in the embodiment, three rows of the bit patterns 120 in the postcode area are arrayed in a single track of the data area, it is not so limited. Any number of rows of the bit patterns 120 may be arrayed in a single track of the data area.

While the bit patterns 122 are described above by way of example as being arranged concentrically, it is not so limited. The bit patterns 122 may be arranged spirally.

Further, in a machine for which compensation of the recording device is not important, the postcode for a recording device may be omitted, and only the postcode for a reproducing device may be provided. With this, the recording capacity for the omitted postcode can be used for data storage.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic recording medium comprising:
a substrate; and
first single domain magnetic dots on the substrate, the first single domain magnetic dots configured to be written with a compensation signal for controlling position of at least one of a recording device and a reproducing device, wherein
the first single domain magnetic dots comprise a length in a radial direction of the substrate shorter than a length in a circumferential direction of the substrate.

2. The magnetic recording medium of claim 1, further comprising:
second single domain magnetic dots concentrically or spirally on the substrate, the second single domain magnetic dots configured to be written with data, wherein
a number of rows of the first single domain magnetic dots in the radial direction is larger than a number of rows of the second single domain magnetic dots in the radial direction.

3. The magnetic recording medium of claim 2, wherein the first single domain magnetic dots and the second single domain magnetic dots comprise a substantially equal area.

4. The magnetic recording medium of claim 2, wherein an aspect ratio of the first single domain magnetic dots is a reciprocal of an aspect ratio of the second single domain magnetic dots.

5. A magnetic storage device comprising:
a driver configured to drive a magnetic recording medium comprising a substrate and a single domain magnetic dot on the substrate and to rotate the magnetic recording medium, the single domain magnetic dot configured to be written with a compensation signal for controlling position of at least one of a recording device and a reproducing device, the single domain magnetic dot comprising a length in a radial direction of the substrate shorter than a length in a circumferential direction of the substrate;
a magnetic head comprising the reproducing device configured to reproduce data from the magnetic recording medium;
a head actuator configured to move the magnetic head in a radial direction of the magnetic recording medium; and
a controller configured to adjust position of the magnetic head by reading the compensation signal written to the single domain magnetic dot of the magnetic recording medium by the reproducing device.
